(19) United States
(12) Patent Application Publication
(10) Pub. No.: US 2026/0160113 A1
(43) Pub. Date: Jun. 11, 2026

(54) DRIVE DEVICE

(71) Applicant: Stabilus GmbH, Koblenz (DE)

(72) Inventor: Jonathan Keßler, Gemünden (DE)

(21) Appl. No.: 19/409,843

(22) Filed: Dec. 5, 2025

(30) Foreign Application Priority Data
Dec. 10, 2024 (DE) 102024137011.4

(51) Int. Cl. E05F 15/662; H02K 5/10

(52) U.S. Cl. CPC E05F 15/662; H02K 5/10

(57) ABSTRACT

The invention relates to a drive device (10) comprising at least a housing (20) as well as a drive assembly (12) partially arranged in the housing (20) and connectable to the housing, with a drive unit (14) arranged non-rotatably on the housing (20), which has a drive housing (24).

According to the invention, at least one connecting element (28) is provided arranged for the indirect connection between the housing (20) and the drive housing (24), which is arranged in a receiving region on an outer side of the drive housing (24) and is connected thereto in a form-fitting manner and is integrally bonded with the housing (20).

The invention further relates to a vehicle (200) with a drive device (10) for a vehicle part movable relative to the body of the vehicle.

The invention relates to a drive device according to the preamble of claim 1. Furthermore, the invention relates to a vehicle with a drive device.

Such drive devices are generally known and usually comprise a housing as well as a drive assembly partially arranged in the housing with a drive unit arranged on the housing in a rotationally fixed manner. The drive unit is, for example, a motor that rotationally drives a drive element. Depending on the use of the drive device, the rotation can be converted into a translation by means of a gearbox arranged in the housing.

Such a drive device is used, for example, in a vehicle, wherein the drive device is provided for moving or for pivoting a movable door or flap element. A drive device of the type mentioned above is known, for example, from DE102022130161A1. Due to the necessary pivoting movement of the movable door or flap element which is attached to the higher-level assembly by means of a hinge or joint connection, it is necessary for the drive device or parts of the drive device to be able to perform a movement adapted thereto, and for a suitable installation space to be provided for this purpose.

However, the installation space provided for the drive device is becoming increasingly limited, in particular due to the increase of further functions and the associated additional components. Therefore, it is necessary to arrange the components of the drive device relative to each other in such a way that it corresponds with the installation space requirements. The drive device known from the prior art therefore has a drive unit which is arranged in a suitable position with respect to the housing. The drive unit is usually screwed to the housing in a predetermined position on the housing or alternatively arranged completely inside the housing.

A form-fitting connection of housing parts is known, for example, from DE102019112682A1. This discloses a spindle drive with a housing tube which, during assembly, is pushed over a spacer axially connected to a drive unit housing in an axially fixed manner to create a form-fitting connection.

Against this background, the object of the invention is to present a drive device improved in terms of cost and installation space. It is also an object of the invention to specify a vehicle comprising such an drive device.

According to the invention, this object is achieved with regard to the drive device by the subject matter of claim 1 and with regard to the vehicle by the subject matter of claim 13.

Specifically, the object is achieved by a drive device that comprises at least one housing as well as a drive assembly partially arranged in the housing with a drive unit arranged on the housing in a rotationally fixed manner. The drive unit can be at least indirectly connected to the housing.

According to the invention, at least one connecting element is arranged for the indirect connection between the housing and the drive housing. The at least one connecting element is arranged in a receiving region on the outside of the drive housing and is connected thereto in a form-fitting manner. Furthermore, at least one connecting element is integrally bonded with the housing.

The connection according to the invention offers particularly advantageous variable positioning of the two components relative to each other and can therefore be adapted to the installation specifications, for example, without further effort. This can optimize the installation space of the drive device, and the drive device can be adapted to a wide variety of different installation situations without any modification effort.

An indirect connection is to be understood as meaning that the two components, the housing and drive unit, are not directly connected to each other. This eliminates, for example, a screw connection between the housing and the drive unit, which minimizes the installation space at the connection point.

Since the connecting element is provided arranged for the indirect connection between the housing and the drive housing of the drive unit, this positioning of the connecting element between the two components to be connected, the housing and drive unit, allows a rotationally fixed connection with suitable connection methods without increasing the installation space.

Preferably, the connecting element can be arranged in a connection region of the drive housing, and a fastening region of the housing can overlap the connection region of the drive housing in such a way that a preload is provided between the connecting element and the components adjoining it. The preload allows the indirect connection to be made with as little play as possible. The integral connection of the connecting element is, for example, to the fastening region of the housing, and the form-fit connection of the connecting element is to the connection region of the drive housing.

Preferably, the connecting element can be designed as a ring element and the receiving region as a groove. The groove and the integral connection are particularly easy to produce in this way.

To make it in particular easy to achieve a rotationally fixed connection between the connecting element and the housing or the fastening region of the housing, a web interrupting the groove of the drive housing can be provided and the ring element can be slotted, wherein the ring ends of the ring element can be applied to the web from opposite sides in such a way that the ring element is arranged in the groove in a rotationally fixed manner. The ring element is therefore provided in essentially a C-shape and formed of plastic, for example, which makes assembly in particular easy.

It has been shown that it is in particular advantageous if the connecting element and the housing are welded together. This connecting technique provides a secure and sufficiently strong connection between the components.

In this case, the housing and the connecting element are preferably made from the same plastic raw material, wherein the housing is laser-transparent, and the connecting element is designed to be laser-absorbing. In addition to the secure welded connection between the housing and the connecting element, this design has the advantage that the housing and the drive housing can be made from different plastics adapted to the requirements. The drive housing, including a motor connector molded thereon, must be temperature-resistant to the waste heat of the motor and is made, for example, of PA66 plastic. The housing, on the other hand, must be geometrically stable and may not absorb water or moisture. Therefore, the housing and the connecting element are made, for example, of a dimensionally stable PBT/PET plastic. By means of the connecting element, it is possible to reliably connect components of different materials that cannot be welded together.

A connection between the housing and the drive unit that is further improved in terms of strength can be made, for example, by providing a plurality of connecting elements for indirect connection. This means that a plurality of ring elements can be arranged in grooves spaced-apart from each other.

For a seal, a sealing element can also be arranged between the housing and the drive housing. The sealing element can, for example, be designed as an O-ring and arranged in an annular space formed by the two components, the housing and drive housing.

Preferably, the drive device is designed as an adjusting device for a door element movable relative to a higher-level assembly, wherein the housing is arranged on the movable door element, and an adjusting element is provided which can be displaced along a displacement axis relative to the drive assembly by means of the drive unit and is designed to be articulated to a free end for assembly on the higher-level assembly.

The door element can be a door or flap element movable relative to the body of a vehicle. For example, the door element is a vehicle side door. However, it should be explicitly mentioned that the door element can also be a tailgate, front hood, or luggage compartment lid. Furthermore, the use of the drive device is not limited to one vehicle. The higher-level building unit can be a motor vehicle, a land vehicle, or a machine with a movable door element. In principle, use for building or furniture doors is also conceivable.

Preferably, the adjusting device is designed as an electric spindle drive.

In this case, the adjusting device can have a slide assembly which can be moved along a rotational axis of a spindle between a first position and a second position by means of a drive unit, wherein the adjusting element is connected to the slide assembly at one end. Furthermore, the slide assembly can include a spindle nut which is in threaded engagement with the rotatable spindle.

An alternative embodiment of the invention provides that a spindle of the spindle drive itself is designed to be longitudinally displaceable and forms the adjusting element. In this design, a rotatably designed spindle nut is provided that is in threaded engagement with the spindle.

A coordinate aspect of the invention relates to a vehicle having an above-described drive device.

The present invention is described below with reference to an exemplary embodiment. In the drawings:

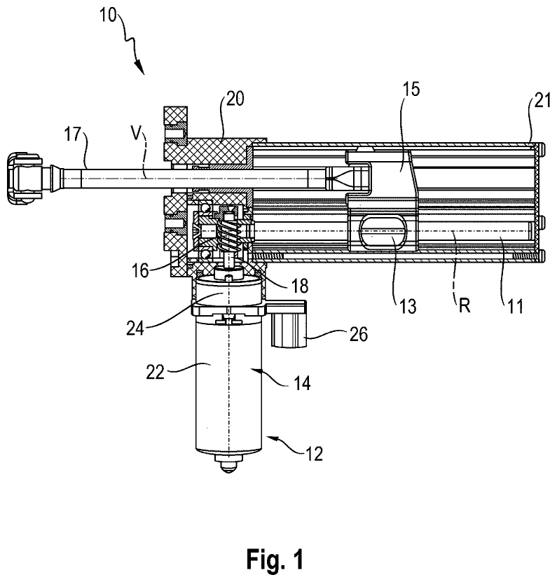

FIG. 1 shows a longitudinal section of a known drive device;

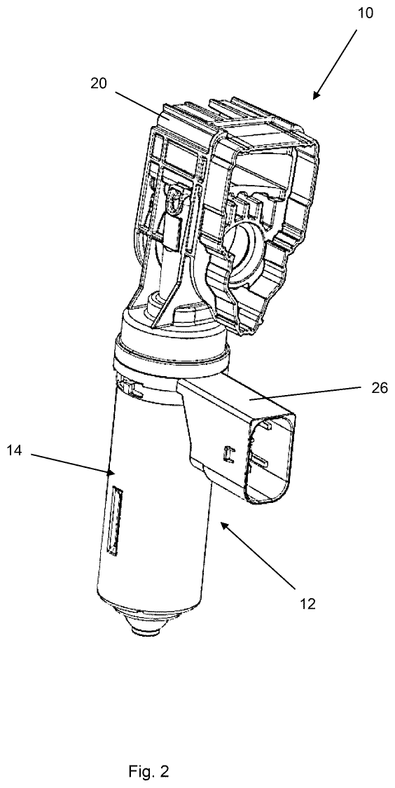

FIG. 2 shows a spatial representation of a drive assembly of a drive device according to the invention with an attached housing;

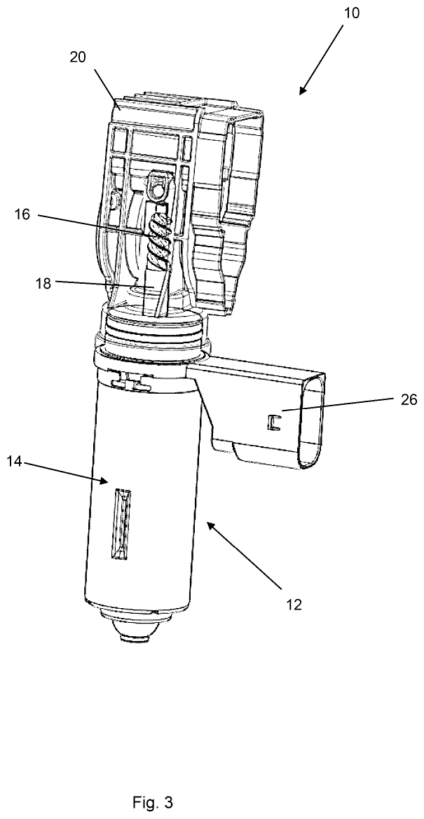

FIG. 3 shows the drive assembly according to FIG. 2 with a transparently shown housing;

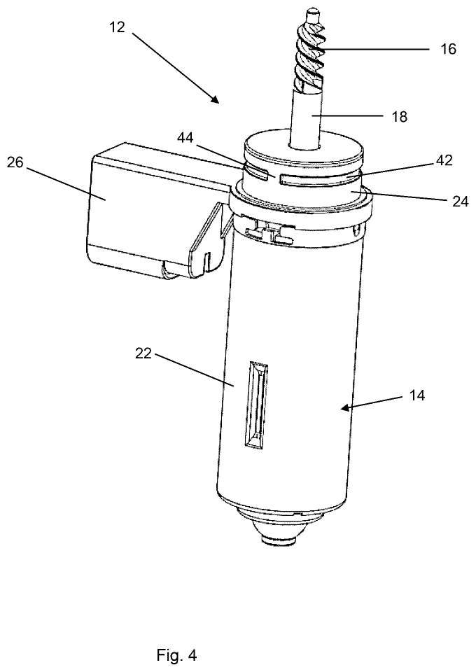

FIG. 4 shows the drive assembly according to FIGS. 2 and 3 without a housing and connecting element;

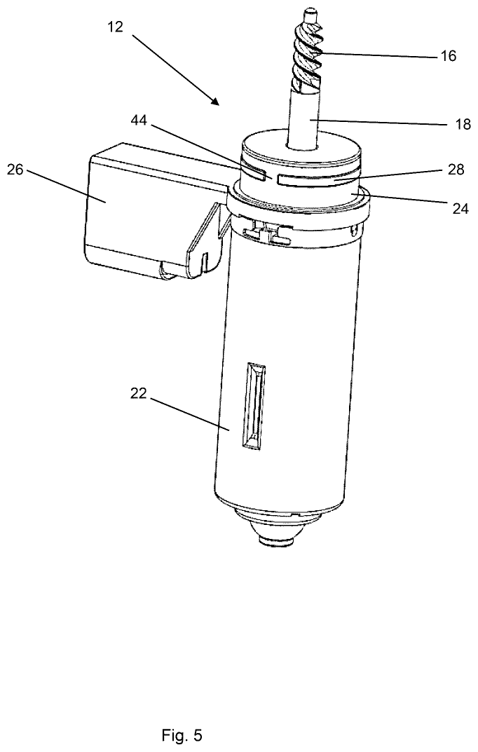

FIG. 5 shows the drive assembly according to FIG. 4 with a mounted connecting element;

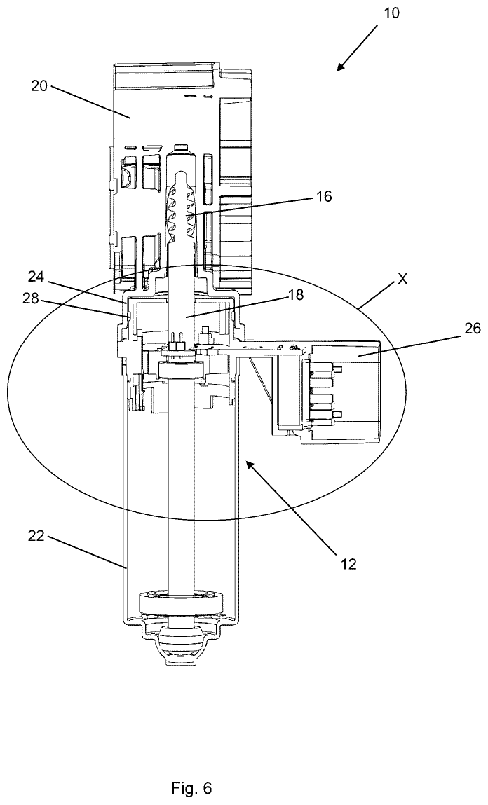

FIG. 6 shows the drive assembly according to FIG. 2 in longitudinal section;

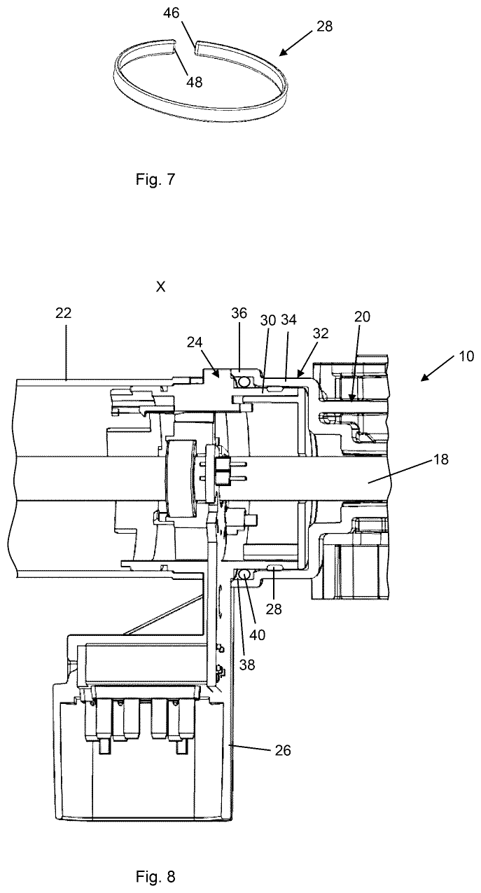

FIG. 7 shows a spatial representation of the connecting element, and

FIG. 8 shows an enlarged section X of the cross-section according to FIG. 6;

FIG. 1 shows a known drive device 10 in longitudinal section. This is designed as an adjusting device for a movable door element. The adjusting device 10 is for example designed as an electric spindle drive. Such an adjusting device is disclosed in the aforementioned earlier application by the applicant DE102022130161A1 which is fully incorporated into the disclosure content of the present application.

It comprises a drive assembly 12 with a drive unit 14 and a drive element 16 driven by the drive unit 14, which can, for example, be designed as a worm that is rotatably driven by the drive unit 14 designed as an electric motor, and meshes with a worm wheel (not shown). In this case, the drive element 16 and the worm wheel form a gear unit.

The worm wheel is fixedly arranged on a spindle 11 so that rotation of the drive element 16 causes rotation of the worm wheel and therefore of the spindle 11. The drive element 16 can be formed in one piece with a motor shaft 18 of the drive unit 14 or, alternatively, can be connected thereto.

The spindle 11 is in threaded engagement with a spindle nut 13, wherein the spindle nut 13 is arranged in a rotationally secured manner relative to a profile housing 21 connected to the housing 20 of the drive device 10 and is therefore displaceable axially along a rotational axis R of the spindle 11 upon rotation of the spindle 11.

The spindle nut 13 is preferably part of a slide assembly 15, which, together with the spindle nut 13, can be displaced along the rotational axis R of the spindle 11 upon rotation of the spindle 11. The slide assembly 15 is connected to an adjusting element 17 which can be designed as an s-shaped door check strap. Alternatively, the adjusting element 17 could also be designed straight.

The adjusting element 17 is articulated at a free end to a movable door element, such as the side door of a vehicle (not shown), or alternatively to a higher-level component, e.g. a vehicle body (not shown). Similarly, the door element can be a tailgate, front hood, or luggage compartment lid. The higher-level building unit can also be a motor vehicle, a land vehicle, or a machine with a movable door element. In principle, a use apart from vehicles, for building or furniture doors, is also conceivable.

Upon activation of the drive unit 14, the spindle 11 is set into rotation, whereby the adjusting element 17 is moved along a displacement axis V via the slide assembly 15 so that the door element can be moved at least between an opening and a closed position.

The drive unit 14 is designed as an electric motor and has a motor housing 22 which is attached to a drive housing 24. The drive housing 24 is referred to as the motor front cap and has a motor connector 26 molded thereon. The drive unit 14 is connected in a rotationally fixed manner to the housing 20 which at least partially accommodates the gear unit by means of the drive housing 24.

The housing 20 as well as the drive housing 24 are each made of plastic.

An embodiment of a drive device 10 according to the invention can be seen in the subsequently described FIGS. 2 to 8. The drive device 10 according to the invention can in principle be constructed in accordance with the known adjusting device shown in FIG. 1. Therefore, identical or similar components are provided with the same reference signs, and only the differences according to the invention will be discussed below. However, the invention is not limited to a drive device 10 described according to FIG. 1.

As described below, the drive unit 14 or its drive housing 24 can be connected at least indirectly to the housing 20. Indirectly means that the two components, the housing 20 and drive unit 14, are not directly connected to each other.

Due to the indirect connection, the positioning of the two components 20, 24 relative to each other is largely variable and can be adapted to different installation requirements without major effort and, in particular, without costs. The variable positioning is in particular advantageous for the alignment of the motor connector 26, and the installation space of the actuator 10 can be optimized.

For indirect connection, a connecting element 28 shown in FIG. 7 is provided between the housing 20 and the drive housing 24 of the drive unit 14, which is preferably designed as a slotted ring element. The connecting element 28 is therefore substantially C-shaped and has two ring ends 46, 48 facing each other.

As can be seen from FIG. 8, which shows an enlarged section X of the longitudinal section according to FIG. 6, the connecting element 28 is arranged between the drive housing 24 and the housing 20 after the assembly of all components. Specifically, the connection is realized in a connection region 30 of the drive housing 24 and a fastening region 32 of the housing 20, wherein the fastening region 32 is designed to overlap the connection region 30. The fastening region 32 is substantially collar-shaped and has two collar regions 34, 36 with different diameters. In particular, a first collar region 34 overlaps the connection region 30 of the drive housing 24 in such a way that a preload is provided between the connecting element 28 and the components adjoining thereon (connection region 30 and collar region 34).

A second collar region 36, which is arranged at the end of the fastening region 32, has a larger diameter and therefore forms an annular space 38 with the connection region 30, in which a sealing element 40 can be arranged. The sealing element 40—preferably an O-ring—reliably seals the connection between housing 20 and drive housing 24.

By positioning the connecting element 28 between the two components to be connected, the housing 20 and drive unit 14, a rotationally fixed connection can be achieved using suitable connection methods without increasing the installation space.

Specifically, the connecting element 28 is provided integrally bonded with the housing 20 and connected in a form-fitting manner with the drive unit 14. The integral connection is made with the fastening region 32 of the housing 20, and the form-fit connection is made to the first collar region 34 of the fastening region 32.

In order to easily achieve the form-fit connection with the connection region 30 of the drive housing 24, the drive housing 24 has a receiving region on an outer side shown in FIG. 4, which is preferably designed as a groove 42 in which the annular connecting element 28 can be mounted. A web 44 interrupting the groove 42 enables the ring ends 46, 48 of the connecting element 28 to be mounted so that a rotationally fixed connection, a torque-transmitting connection is created. FIG. 4 shows the drive assembly 12 without a housing 20 and without a connecting element 28. In contrast, FIG. 5 shows the drive assembly 12 without a housing 20 with the connecting element 28 inserted into the groove 42.

The integral connection between the fastening region 32 and the connecting element 28 is made after the housing 20 has been mounted by means of a laser welding method. In this case, the housing 20 and the connecting element 28 are made of the same plastic raw material, wherein the housing 20 is laser-transparent and the connecting element 28 is designed to be laser-absorbing. For example, a PBT/PET plastic is suitable as the plastic raw material for the housing 20 and the connecting element 28 since this ensures dimensional stability. By using a suitable dye (e.g., carbon black), it can be made laser-absorbing.

The drive housing 24 including the motor connector 26 molded thereon must be temperature-resistant due to the waste heat from the motor and is therefore made of a different plastic raw material (e.g., PA66).

By means of the connecting element 28, it is therefore possible to reliably connect components of different plastics that cannot be welded together.

The pre-tensioned mounting of the fastening region 32 on the connecting element 28 facilitates improved heat transfer during the welding process and ensures a connection with as little play as possible.

The adjusting device 10 is described as an electric spindle drive with an additional adjusting element 17 with which a rotation of the spindle 11 is converted into a translation of the spindle nut 15 and the adjusting element 17 articulated thereto. In an alternative embodiment of an electric spindle drive (not shown), a spindle nut rotates and moves the spindle as an adjusting element along an adjustment axis.

The invention is not limited to the described embodiments and can also be applied to other drive devices/adjusting devices.

1. A drive device comprising: a housing; a drive assembly partially arranged and connectable to the housing; and a drive unit arranged non-rotatably on the housing, which has a drive housing, wherein at least one connecting element, configured to indirectly connect between the housing and the drive housing, is arranged in a receiving region on an outer side of the drive housing and is connected thereto in a form-fitting manner and which is integrally bonded with the housing.

2. The drive device according to claim 1, wherein the at least one connecting element is arranged in a connection region of the drive housing, and a fastening region of the housing overlaps the connection region of the drive housing in such a way that a preload is provided between the connecting element and the components adjoining thereon.

3. The drive device according to claim 1, wherein the at least one connecting element is a ring element and the receiving region is a groove.

4. The drive device according to claim 3, further comprising a web interrupting the groove of the drive housing and the ring element is slotted, wherein ring ends of the ring element can be applied to the web from opposite sides in such a way that the ring element is arranged in the groove in a rotationally fixed manner.

5. The drive device according to claim 1, wherein the connecting element and the housing are welded together.

6. The drive device according to claim 5, wherein the housing and the at least one connecting element comprise the same plastic raw material, wherein the housing is laser-transparent and the at least one connecting element is laser-absorbing.

7. The drive device according to claim 1, wherein the at least one connecting element comprises a plurality of connecting elements that are provided for indirect connection.

8. The drive device according to claim 1, further comprising a sealing element arranged between the housing and the drive housing for sealing.

9. The drive device according to claim 1, wherein the drive device is an adjusting device for a door element movable relative to a higher-level assembly, wherein the housing is arranged on the movable door element, and further comprising an adjusting element displaceable along a displacement axis relative to the drive assembly by the drive unit and configured to be articulated to a free end for assembly on the higher-level assembly.

10. The drive device according to claim 9, wherein the door element is a door or flap element movable relative to a body of a vehicle.

11. The drive device according to claim 9, wherein the adjusting device is an electric spindle drive and has an electric motor.

12. The drive device according to claim 11, further comprising a slide assembly which can be moved along a rotational axis of a spindle between a first position and a second position by the drive unit wherein the adjusting element is connected to the slide assembly at one end.

13. A vehicle comprising: a body; a vehicle part movable relative to the body; and the drive device of claim 1 coupled to the vehicle part.
